(19) United States
(12) Patent Application Publication
(10) Pub. No.: US 2016/0006373 A1
(43) Pub. Date: Jan. 7, 2016

(54) Thermoelectric Generator

(71) Applicant: SPX CORPORATION, Charlotte, NC (US)

(72) Inventor: Spencer D. Conard, Charlotte, NC (US)

(21) Appl. No.: 14/854,522

(22) Filed: Sep. 15, 2015

Related U.S. Application Data
(63) Continuation of application No. PCT/US14/30956, filed on Mar. 18, 2014.
(60) Provisional application No. 61/792,464, filed on Mar. 15, 2013.

(51) Int. Cl. H02N 2/18

(52) U.S. Cl. CPC H02N 2/18

(57) ABSTRACT

A thermoelectric generator includes a shape memory material configured to change shape due to a change in temperature, the shape memory material being further configured to cyclically receive heat from a heat source. The thermoelectric generator further includes a piezoelectric material coupled to the shape memory material, the piezoelectric material configured to produce electricity in response to the changed shape of the shape memory material.

### CROSS-REFERENCE TO RELATED APPLICATIONS

This application is a continuation of International Application No. PCT/US2014/030956, filed Mar. 18, 2014 and designating the U.S., which claims priority to U.S. Provisional Application No. 61/792,464 filed on Mar. 15, 2013, which is hereby incorporated by reference in its entirety for all purposes as if fully set forth herein.

### FIELD OF THE DISCLOSURE

The disclosure relates generally to thermoelectric generator devices and methods for generating thermoelectricity. More particularly, the disclosure relates generally to thermoelectric generator devices and methods for generating thermoelectricity utilizing piezoelectric materials and shape memory materials.

### BACKGROUND OF THE DISCLOSURE

Conventionally, devices having piezoelectric materials (e.g., zinc oxide strands) with a plastic matrix are known to produce electricity when flexed or strained. Such materials are discussed for example in “Power Generation with Laterally Packaged Piezoelectric fine Wires,” to Yang et al., published online on Nov. 9, 2008.

Separately, conventional shape memory polymers typically change shape and recover back to a previous shape when a temperature thereof is cycled. Such materials have been used, for example, in biomedical and commodity applications.

Independently, there exist many sources of waste heat including power plants, vehicles, machines, refrigeration devices, electrical devices, human bodies, solar sources, biological reactions, or the like. Outside their specific applications, these sources of heat typically provide little if any additional productive use of the remaining waste heat. Moreover, the sources of heat may be detrimental to the environment.

Accordingly, there is a need to more productively use the waste heat generated by various heat sources.

### SUMMARY OF THE DISCLOSURE

According to an aspect, a thermoelectric generator includes a shape memory material configured to change shape due to a change in temperature, the shape memory material being further configured to cyclically receive heat from a heat source, and a piezoelectric material coupled to the shape memory material, the piezoelectric material configured to produce electricity in response to the changed shape of the shape memory material.

According to an aspect, a method of generating thermoelectricity includes providing a thermoelectric generator including a shape memory material coupled to a piezoelectric material, transferring heat from a heat source to the thermoelectric generator, generating thermoelectricity, and discontinuing the transfer of heat from the heat source to the thermoelectric generator.

According to yet another aspect, a thermoelectric generator system includes a shape memory material configured to change shape due to a change in temperature, the shape memory material being further configured to cyclically receive heat from a heat source, a piezoelectric material coupled to the shape memory material, the piezoelectric material configured to produce electricity in response to the changed shape of the shape memory material, and a device to capture and utilize the electricity produced by the piezoelectric material.

There has thus been outlined, rather broadly, certain aspects in order that the detailed description thereof herein may be better understood, and in order that the present contribution to the conventional art may be better appreciated. There are, of course, additional aspects of the disclosure that will be described below, which will form the subject matter of the claims appended hereto.

In this respect, before explaining at least one aspect in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, apparatii, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 shows a schematic of a thermoelectric generator according to one aspect of the disclosure.

FIG. 2 shows a specific application of a thermoelectric generator according to another aspect of the disclosure.

FIG. 3 shows a process of using a thermoelectric generator according to another aspect of the disclosure.

### DETAILED DESCRIPTION

The disclosure will now be described with reference to the drawing figures, in which like reference numerals refer to like parts throughout. Aspects of the disclosure advantageously provide a thermoelectric generator. The thermoelectric generator includes a shape memory material and a piezoelectric material. The piezoelectric material is coupled to the shape memory material that is configured to change shape due to a change in temperature, such that the piezoelectric material generates electricity due to interaction by the changed shape of the shape memory material.

The shape memory material of the disclosure may include a plastic, an alloy, combinations thereof, or the like. In one aspect, the shape memory material may have a two-way shape-memory effect. The two-way shape-memory effect may allow the material to remember two different shapes: one at low temperatures, and one at a high-temperature. In this regard, it is contemplated that the shape memory material of the disclosure may include any material capable of at least two different shapes: one at lower temperatures and one at higher temperatures.

By way of example only and not by way of limitation, such shape memory materials may include Copper based materials, Nickel-Titanium based materials, etc. Such shape memory materials may be selected and utilized based, for example, on a primary element, mode of actuation, operational temperature, or desired behavior. Further examples of such shape memory materials include, but are not restricted to, Silver-Cadmium, Gold-Cadmium, Copper-Aluminum, Copper-Tin, Copper-Zinc, Iron-Platinum, Manganese-Copper, Iron-Manganese-Silicon, Platinum based alloys, Cobalt-Nickel-Aluminum, Cobalt-Nickel-Gallium, Nickel-Iron-Gallium, Titanium-Palladium in various concentrations, Nickel-Titanium-Niobium, Nickel-Manganese-Gallium, combinations thereof, or the like, in various proportions.

Moreover, the shape memory material may include shape-memory alloys of Copper-Aluminum-Nickel, and Nickel-Titanium (NiTi) alloys. The shape memory material may also be created by alloying Zinc, Copper, Gold and Iron. Iron-based and copper-based shape memory materials may include Fe—Mn—Si, Cu—Zn—Al and Cu—Al—Ni. The shape memory material may exist in two different phases, with possibly three different crystal structures (i.e. twinned martensite, detwinned martensite and austenite) and possibly six possible transformations. For example, NiTi alloys may change from austenite to martensite upon cooling. Accordingly, during heating the shape memory material may transform from martensite to austenite.

The piezoelectric material includes any material capable of internal generation of electrical charge resulting from an applied mechanical force. For example, the piezoelectric material may include Zinc Oxide strands, e.g., arranged as nanowires, although other materials such as Quartz, Barium Titanate, Lead Niobate, Lead Zirconate Titanate, combinations thereof, or the like, may be used. For example, the following materials may be utilized as a piezoelectric material: Barium Titanate (BaTiO₃), Lead Titanate (PbTiO₃), Lead Zirconate Titanate (Pb[ZrₓTi1₋ₓ]O₃ 0≦x≦1) also commonly known as PZT, Potassium Niobate (KNbO₃), Lithium Niobate (LiNbO₃), Lithium Tantalate (LiTaO₃), Sodium Tungstate (Na₂WO₃), Zinc Oxide (ZnO), Ba₂NaNb₅O₅, Pb₂KNb₅O₁₅, and the like.

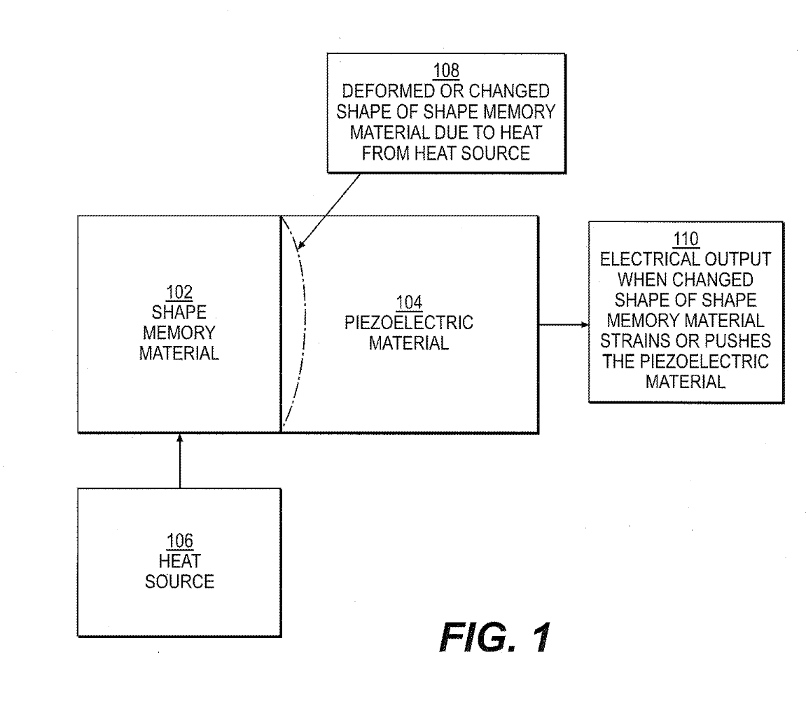

FIG. 1 shows a schematic of a thermoelectric generator according to one aspect of the disclosure. In particular, as shown in FIG. 1 a shape memory material 102 may be arranged in conjunction with a piezoelectric material 104. The arrangement of the shape memory material 102 may be such that when the shape memory material 102 changes shape, when a surrounding temperature is changed, the associated piezoelectric material 104 may be physically moved, squeezed, mechanically forced, manipulated, strained and/or the like by the shape memory material 102.

The arrangement of the shape memory material 102 and piezoelectric material 104 may be any arrangement that results in the shape memory material 102 being physically moved, squeezed mechanically forced, manipulated, strained and/or the like by the shape memory material 102. For example, the shape memory material 102 and piezoelectric material 104 may be held together in a matrix, may be woven together, may be arranged in parallel, may be arranged linearly, may be arranged with mechanical connections, may be adhered together, may be held together with fasteners, or the like.

As further shown in FIG. 1, a heat source 106 may be arranged to provide a source of heat to the shape memory material 102. It should be noted that heat source 106 may conversely be a cold source. Heat from the heat source 106 may directed to the shape memory material 102 and thus result in a deformation or change in shape 108 of the shape memory material 102. Once the shape memory material 102 has changed shape, thereafter application of heat from the heat source 106 may be stopped or reduced to result in the shape memory material 102 returning to its original shape.

Movement or manipulation of the piezoelectric material 104 will result in the generation of electricity, an electrical output, or an electrical current which may be captured by electricity usage device 110. The electricity usage device 110 may then utilize the electricity as desired.

The heat source 106 may be any source of heat or cold. For example, heat source 106 may be heat generated from a power plant, a vehicle, a machine, a refrigeration device, an electrical device, a human body, a solar source, a biological reaction or the like. For example, the heat source may be heat generated in a power plant that includes a cooling tower operating to dissipate heat from the power plant. For example, a nuclear powered power plant, at coal powered power plant, or the like. Such heat may be waste heat.

Alternatively, the heat may be generated from a combustion engine in a vehicle and the heat source 106 may be associated with the combustion engine or the exhaust from a combustion engine. In yet another alternative, the heat source may be from a refrigeration unit that is dissipating heat in conjunction with the generation of refrigerated air. In yet another alternative, the heat source may be from an electrical component such as a transformer, computer, or the like generating heat during operation thereof. In yet a further alternative, the heat source may be solar based with the heat being generated based on sunlight. In an additional alternative aspect, the heat source may be from the human body. In this regard, the thermoelectric generation device may be worn by a user near or in contact with their body. In a further alternative aspects, the thermoelectric generation device may be utilized in conjunction with a biological reaction. For example, the thermoelectric generation device may be utilized with a decomposition process of biological matter.

Heat from the heat source 106 may be extracted from the heat source based on convection, conduction, radiation, and/or the like. For example, the heat from the heat source 106 may be transferred with air, some other gas, liquid, or the like being utilized to remove the heat from the heat source 106 and transfer the heat to the shape memory material 102 through the use of ducts, channels, pipes or the like. Alternatively or additionally, the heat from the heat source 106 may be transferred to the shape memory material 102 through the use of intermediate materials via conduction. It should be noted that any type of heat transfer is contemplated by the disclosure.

The heat source 106 may be configured to cyclically provide the source of heat (or cold) to the shape memory material 102. In this regard, the heat source 106 may include a controller to control the transfer of heat from the heat source 106 to the shape memory material 102. The controller may include dedicated hardware and/or a computing device as defined herein. The controller may include software. For example, the controller may include a processor, random access memory, a read-only memory, input devices, output devices, and the like. The input devices may include temperature sensing devices to sense the temperature of the shape memory material 102 and the heat source 106. For example, the temperature sensing devices may be thermocouples, thermistors, and the like. The input devices may further include measurement devices to measure movement of the piezoelectric material 104. For example the measurement devices may include strain gages, load cells, potentiometers, and the like. The output devices may include displays, signaling devices, solenoids and drivers. In particular, the output devices may be configured to control the heat provided by the heat source 106. For example, the output devices may operate a solenoid to open a series of ducts to guide heated air to the shape memory material 102. After an input device such as a potentiometer senses the shape memory material 102 has changed shape, the output device/solenoid may close a series of ducts to stop application of heat to the shape memory material 102. Thereafter, the process may be repeated.

The electricity usage device 110 is configured to store and/or utilize the electricity generated by the piezoelectric material 104. In particular, the electricity usage device 110 may include wires, terminals, and the like connecting to the piezoelectric material 104 in order to capture electricity generated by the piezoelectric material 104. The electricity usage device 110 may include batteries, inverters, transformers, or the like. The electricity usage device 110 may be used to drive a load.

Accordingly, the system shown in FIG. 1 utilizes waste heat generated from the heat source 106 to generate electricity that may be utilized in a productive manner. Moreover, the productive generation of electricity may have a positive environmental impact and reduce an overall carbon footprint of the system.

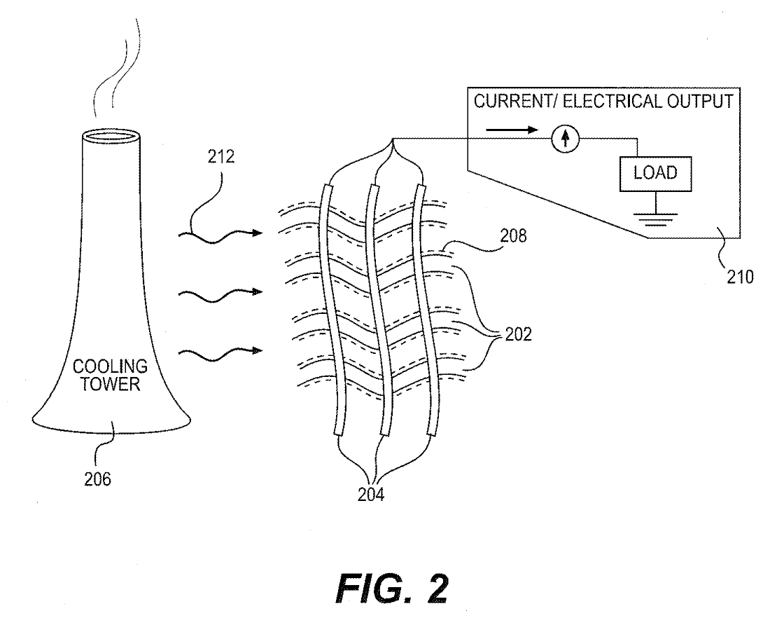

FIG. 2 shows a specific application of a thermoelectric generator according to one aspect of the disclosure. In particular, as shown in FIG. 2 a shape memory material 202 may be arranged in conjunction with a piezoelectric material 204 implemented together with a heat source 206 that is a cooling tower. The cooling tower may be associated with a power plant or any refrigeration system. In this case, the shape memory material 202 may form a matrix with the piezoelectric material 204. Alternatively, the shape memory material 202 may be woven with the piezoelectric material 204. Other configurations are contemplated.

The arrangement of the shape memory material 202 may be such that the shape memory material 202 changes shape when a surrounding temperature is changed in response to heat 212 from the cooling tower. Thereafter, the associated piezoelectric material 204 may be physically moved or manipulated by the shape memory material 202. For example, a change in temperature of the shape memory material 202 may result in an expansion 208.

For example, heat from the heat source 206 may result in a deformation, expansion or change in shape 208 of the shape memory material 202. As further shown in FIG. 2, the heat source 206 may be a source of heat 212 to the shape memory material 202. The heat source 212 may be heat/thermal radiation generated from the heat source 206. Stopping application of heat 212 from the heat source 206 may result in the shape memory material 202 returning to its original shape.

In this regard, the heat source 206 may include a controller to control the transfer of heat from the heat source 206 to the shape memory material 202. The controller may include dedicated hardware and/or a computing device as defined herein. The controller may include software. For example, the controller may include a processor, random access memory, a read-only memory, input devices, output devices, and the like. The input devices may include temperature sensing devices to sense the temperature of the shape memory material 202 and the heat source 206. For example, the temperature sensing devices may be thermocouples, thermistors, and the like. The input devices may further include measurement devices to measure movement of the piezoelectric material 204. For example the measurement devices may include strain gages, load cells, and the like.

Movement or manipulation of the piezoelectric material 204 will result in the generation of electricity, an electrical output, or an electrical current which may be captured by an output device 210. The output device 210 may then utilize the electricity as desired and apply the electricity to a load for example.

Accordingly, the system shown in FIG. 2 utilizes waste heat generated from the power plant (heat source 206) to generate electricity that may be utilized in a productive manner. Moreover, the productive generation of electricity may have a positive environmental impact and reduce an overall carbon footprint of the power plant.

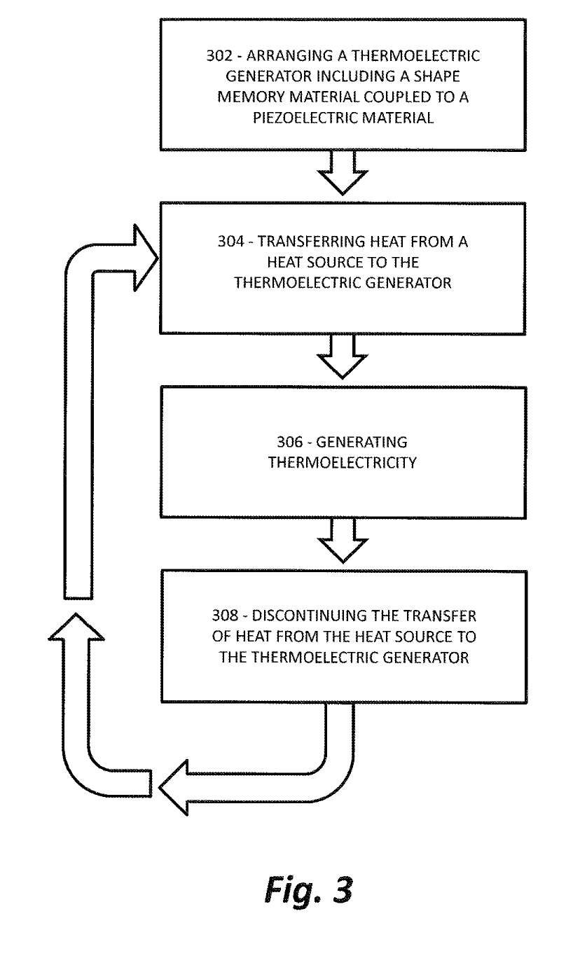

FIG. 3 shows a process of using a thermoelectric generator according to another aspect of the disclosure. According to this aspect, a method of generating thermoelectricity is provided. The method includes arranging a thermoelectric generator including a shape memory material coupled to a piezoelectric material 302. The arrangement of the thermoelectric generator being close to or near a heat source. The placing a thermoelectric generator including a shape memory material coupled to a piezoelectric material next to or near a heat source may or may not include the arrangement of the shape memory material 102, 202, the piezoelectric material 104, 204, and heat source 106, 206 as described herein.

The method may further include transferring heat from a heat source to the thermoelectric generator 304. As described herein, the heat may be provided by convection, conduction, radiation and/or the like. The transferring may include transferring with air, some other gas, liquid, or the like being utilized to remove the heat from the heat source and the heat transferred to the shape memory material through the use of ducts, channels, pipes or the like. Alternatively, the heat from the heat source may be transferred to the shape memory material through the use of intermediate materials through conduction.

The method includes generating thermoelectricity 306 based upon a change in temperature provided by the heat source that causes the shape memory material to change shape and causes the piezoelectric material to output electricity based upon the changed shape of the shape memory material, wherein the changed shape of the shape memory material strains the piezoelectric material.

The method may further include discontinuing the transfer of heat from the heat source to the thermoelectric generator 308. The discontinuing the transfer may also involve providing a cold source to the thermoelectric generator. This results in the shape memory material returning to its initial shape. The process may then be repeated to produce additional electricity. The method of generating electricity may include dedicated hardware, software and/or a computing device as defined herein to oversee and control the method.

In one aspect, plastic matrix used in conventional piezoelectric generator may be substituted with a shape memory material to result in the thermoelectric generator of the present disclosure. The thermoelectric generator may also be interchangeably referred to as a thermogenerator. Changes in temperature cause piezoelectric generator to strain and generate electricity. This is used for generating electricity from heat sources, for example low grade waste heat of cooling towers at power plants. Depending on the temperatures involved, different polymers or alloys of the shape memory material may be used to achieve the desired levels of strain during heating and cooling, and hence to attain the desired electrical output from the piezoelectric based thermogenerator.

By way of example only, if Δt is the change in temperature received by the shape memory material, the mathematical relationship between the variables may include:

Δi=kf(Δx), such that Δx=pg(Δt),
where
Δi=change in output electrical current T from the thermoelectric generator;
Δx=change in shape along a direction ‘x’ of the piezoelectric material due to strain caused by bending of the shape memory material;
k, p are proportionality parameters; and
f(.) and g(.) are function operators.

In other words, Δx α Δt; and Δi α Δx, and therefore Δi α Δt, where α denotes proportionality.

The method may include manufacturing or creating a thermoelectric generator made using the steps of the method. Such steps of the method may include intertwining or meshing piezoelectric material (e.g., zinc oxide strands) with shape memory materials (e.g., plastics or alloys). Alternatively, such steps may include coupling the piezoelectric material with or connecting it to the shape memory material. For example, such coupling may include direct contact between the piezoelectric material and the shape memory material.

The heat source may be waste heat generated from the cooling tower of a power plant or other heat sources as described herein. Alternatively, the heat source may be a human body to which the thermoelectric generator is attached to generate thermoelectricity based on human body temperature change. Such thermoelectricity may be used to charge, for example, wearable electronic devices, such as music players, pedometers, pacemakers, smart phones, communication devices, combat related military components, and the like.

The disclosure may be implemented in conjunction with any type of computing devices, such as, e.g., a desktop computer, personal computer, a laptop/mobile computer, a personal data assistant (PDA), a mobile phone, a tablet computer, cloud computing device, and the like.

Further in accordance with various aspects of the disclosure, the methods described herein may be intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

The many features and advantages of the aspects discussed herein are apparent from the detailed specification, and thus, it is intended by the appended claims to cover all such features and advantages which fall within the true spirit and scope of the aspects. Further, since numerous modifications and variations will readily occur to those skilled in the art, it is not desired to limit the exact construction and operation illustrated and described, and accordingly, all suitable modifications and equivalents may be resorted to, falling within the scope of the aspects in the present disclosure.

What is claimed is:

1. A thermoelectric generator, comprising:
a shape memory material configured to change shape due to a change in temperature, the shape memory material being further configured to cyclically receive heat from a heat source; and
a piezoelectric material coupled to the shape memory material, the piezoelectric material configured to produce electricity in response to the changed shape of the shape memory material.

2. The thermoelectric generator of claim 1, wherein the shape memory material comprises at least one of the following: a plastic and an alloy.

3. The thermoelectric generator of claim 1, wherein the piezoelectric material comprises zinc oxide strands.

4. The thermoelectric generator of claim 1, wherein the piezoelectric material comprises zinc oxide strands arranged as nanowires.

5. The thermoelectric generator of claim 1, wherein the shape memory material and piezoelectric material are configured together in at least one of a matrix, in a woven construction, in a parallel construction, in a linear construction, with mechanical connections, with an adhesive construction, and with fasteners.

6. The thermoelectric generator of claim 1, further comprising the heat source comprising at least one of the following: a power plant, a vehicle, a machine, a refrigeration device, an electrical device, a solar source, and a biological reaction.

7. The thermoelectric generator of claim 1, further comprising the heat source and the heat source is configured to cyclically provide heat to the shape memory material.

8. The thermoelectric generator of claim 1, further comprising:
the heat source and the heat source is further configured to control operation of at least one of the following: the heat source, the shape memory material and the piezoelectric material.

9. A method of generating thermoelectricity, comprising:
providing a thermoelectric generator including a shape memory material coupled to a piezoelectric material;
transferring heat from a heat source to the thermoelectric generator;
generating thermoelectricity; and
discontinuing the transfer of heat from the heat source to the thermoelectric generator.

10. The method of claim 9, wherein the shape memory material comprises at least one of the following: a plastic and an alloy.

11. The method of claim 9, wherein the piezoelectric material comprises zinc oxide strands.

12. The method of claim 9, wherein the piezoelectric material comprises zinc oxide strands arranged as nanowires.

13. The method of claim 9, wherein the heat source comprises at least one of the following: a power plant, a vehicle, a machine, a refrigeration device, an electrical device, a solar source, and a biological reaction.

14. The method of claim 9, further comprising:
controlling operation of at least one of the following: the heat source, the shape memory material and the piezoelectric material.

15. A thermoelectric generator system, comprising:
a shape memory material configured to change shape due to a change in temperature, the shape memory material being further configured to cyclically receive heat from a heat source;
a piezoelectric material coupled to the shape memory material, the piezoelectric material configured to produce electricity in response to the changed shape of the shape memory material; and
a device to capture and utilize the electricity produced by the piezoelectric material,
wherein the shape memory material and piezoelectric material are configured together in at least one of a matrix, in a woven construction, in a parallel construction, in a linear construction, with mechanical connections, with an adhesive construction, and with fasteners.

16. The thermoelectric generator system of claim 15, wherein the piezoelectric material comprises zinc oxide strands.

17. The thermoelectric generator system of claim 15, wherein the piezoelectric material comprises zinc oxide strands arranged as nanowires.

18. The thermoelectric generator system of claim 15, further comprising the heat source comprising at least one of the following: a power plant, a vehicle, a machine, a refrigeration device, an electrical device, a human body, a solar source, and a biological reaction.

19. The thermoelectric generator system of claim 15, further comprising the heat source and the heat source is configured to cyclically provide heat to the shape memory material.

20. The thermoelectric generator system of claim 15, further comprising:
the heat source and the heat source is further configured to control operation of at least one of the following: the heat source, the shape memory material and the piezoelectric material.
